(19) United States
(12) Patent Application Publication
(10) Pub. No.: US 2018/0074558 A1
(43) Pub. Date: Mar. 15, 2018

(54) SUPPORTING DEVICE FOR ELECTRONIC DEVICE

(71) Applicant: PRIMAX ELECTRONICS LTD., Taipei (TW)

(72) Inventors: Yi-Chen Chung, Taipei (TW); Chin-Sung Pan, Taipei (TW)

(21) Appl. No.: 15/371,791

(22) Filed: Dec. 7, 2016

(30) Foreign Application Priority Data
Sep. 9, 2016 (TW) 105129346

(51) Int. Cl. G06F 1/16; E05F 1/12; E05D 11/06; E05D 11/00; E05D 3/02

(52) U.S. Cl. CPC G06F 1/1681; E05F 1/1207; E05D 11/06; E05D 11/0054; E05D 2011/0072; G06F 1/166; G06F 1/1679; E05Y 2900/606; E05D 3/02

(57) ABSTRACT

A supporting mechanism for an electronic device includes a base, a fixing plate, a supporting frame and a rotating module. The fixing plate can receive the electronic device. The fixing plate is placed on the base and rotatable relative to the base. The supporting frame is placed on the fixing plate and rotatable relative to the fixing plate. The rotating module is connected with the base, the fixing plate and the supporting frame. After the fixing plate is rotated relative to the base and the supporting frame is moved with the fixing plate by a predetermined angle, the supporting frame is rotated relative to the fixing plate but not synchronously rotated with the fixing plate according to the operation of the rotating module. By simply uplifting or covering the fixing plate and not operating the supporting frame, the electronic device can be controlled as required.

### FIELD OF THE INVENTION

The present invention relates to a supporting device, and more particularly to a supporting device for an electronic device.

### BACKGROUND OF THE INVENTION

With increasing development of science and technology, the general trends in designing electronic devices are toward small size, light weightiness and easy portability. Generally, the display screen of the electronic device is a touch screen. Via the touch screen, the user may input commands into the electronic device to control operations of the electronic device. Since the small-sized electronic device can only withstand a relatively lower impact, if the touch screen is damaged, the handling capability of the electronic device is deteriorated. In other words, it is important to protect the electronic device. Moreover, the user cannot continuously operate the electronic device while holding the electronic device with hands for a long time. Therefore, it is necessary to provide a supporting device for fixing the electronic device.

As a consequence, a supporting device for an electronic device has been introduced into the market. Please refer to FIGS. 1, 2 and 3. FIG. 1 is a schematic exploded view illustrating a conventional supporting device for an electronic device. FIG. 2 is a schematic perspective view illustrating the conventional supporting device in a storing mode. FIG. 3 is a schematic perspective view illustrating the conventional supporting device in an operating mode. When an electronic device 2 is stored within the supporting device 1, the electronic device 2 and a display screen 20 of the electronic device 2 are protected by the supporting device 1. For example, the electronic device 2 is a tablet computer, and the display screen 20 is a touch screen. As shown in FIGS. 1, 2 and 3, the supporting device 1 comprises a protective cover 10 and a supporting plate 11. The protective cover 10 is used for covering the electronic device 2. In addition, the protective cover 10 has a hollow part 101, a first engaging part 102, an entrance 103, a sealing piece 104, plural first magnetic elements 105, plural second magnetic elements 106 and plural third magnetic elements 107. The supporting plate 11 can enclose the protective cover 10 or support the protective cover 10. In addition, the supporting plate 11 comprises plural stopping plates 111, a base body 112, a foldable piece 113, a foldable groove 114, a covering plate 115, a second engaging part 116 and plural fourth magnetic elements 117.

The hollow part 101 is formed in a front surface of the protective cover 10. After the electronic device 2 is covered by the protective cover 10, the electronic device 2 is exposed to the outside through the hollow part 101 in order to be operated (see FIG. 3). The first engaging part 102 is disposed on a rear surface of the protective cover 10. The entrance 103 is located at a first long side of the protective cover 10. Through the entrance 103, the electronic device 2 can be accommodated within the protective cover 10 or removed from the protective cover 10. The sealing piece 104 is located at the first long side of the protective cover 10 for sealing the entrance 103. Consequently, the electronic device 2 within the protective cover 10 is not detached from the entrance 103. The first magnetic elements 105 are disposed on the first long side of the protective cover 10 and at the locations corresponding to the sealing piece 104. The second magnetic elements 106 are located at an end of the sealing piece 104. When the entrance 103 is sealed by the sealing piece 104, the second magnetic elements 106 and the first magnetic elements 105 are magnetically attracted by each other. Since the second magnetic elements 106 and the first magnetic elements 105 are magnetically attracted by each other, the sealing piece 104 can be securely fixed on the first long side of the protective cover 10. In addition, the third magnetic elements 107 are disposed on the rear surface of the protective cover 10.

The plural stopping plates 111 of the supporting plate 11 are located at a first side of the base body 112 of the supporting plate 11. In addition, every two adjacent stopping plates 111 are separated from each other by an appropriate gap. The plural stopping plates 111 are used for stopping a second long side of the protective cover 10 in order to prevent the protective cover 10 from being slid on the base body 112. The foldable piece 113 is located at a second side of the base body 112. Moreover, the size of the foldable piece 113 is determined according to the thickness of the electronic device 2. The covering plate 115 is extended from the foldable piece 113. The covering plate 115 may be combined with the protective cover 10. Alternatively, the protective cover 10 may be supported by the covering plate 115. The foldable groove 114 is formed in the covering plate 115. Due to the foldable groove 114, the covering plate 115 may be bent at different angles to support the protective cover 10. The second engaging part 116 is disposed on the covering plate 115. Due to the engagement between the second engaging part 116 and the first engaging part 102, the protective cover 10 and the supporting plate 11 are combined together. The fourth magnetic elements 117 are disposed on an edge of the base body 112 and at the locations corresponding to the third magnetic elements 107 so as to be magnetically attracted by the third magnetic elements 107. When the fourth magnetic elements 117 and the third magnetic elements 107 are magnetically attracted by each other, the protective cover 10 is securely fixed on the base body 112.

After the electronic device 2 is used, the electronic device 2 can be stored. For storing the electronic device 2, the electronic device 2 is firstly covered by the protective cover 10, and then the second engaging part 116 and the first engaging part 102 are engaged with each other. Consequently, the protective cover 10 and the supporting plate 11 are combined together, and the protective cover 10 is covered by the supporting plate 11. Meanwhile, the fourth magnetic elements 117 and the third magnetic elements 107 are magnetically attracted by each other, and thus the protective cover 10 is securely fixed on the supporting plate 11.

For using the electronic device 2, two approaches of operating the supporting device 1 are provided. In accordance with the first approach, the second engaging part 116 and the first engaging part 102 are disengaged from each other, so that the protective cover 10 is detached from the supporting plate 11. Under this circumstance, the user can hold the electronic device 2 with hands in order to operate the electronic device 10.

The second approach of operating the supporting device 1 will be described as follows. Please refer to FIG. 3 again. In this approach, the second engaging part 116 and the first engaging part 102 are engaged with each other. Consequently, the protective cover 10 and the supporting plate 11 are combined together. Then, the covering plate 115 is bent to support the protective cover 10. Moreover, the second long side of the protective cover 10 is stopped by one of the stopping plates 111 in order to prevent the protective cover 10 from being slid on the base body 112. According to the second approach, the protective cover 10 is fixed on the supporting plate 11 in a horizontal-placement status. Meanwhile, the supporting device 1 is in an operating mode and in a horizontal-placement status.

According to the second operating approach, the touch screen 20 of the electronic device 2 is severed as a general display screen. Moreover, an external keyboard (not shown) is connected with the electronic device 2. Through the external keyboard, characters or symbols can be inputted into the electronic device 2 in order to comply with the usual practice of most users to operate the desktop computer or the notebook computer. Moreover, the external keyboard may be connected to the electronic device 2 through a universal serial bus (USB). Alternatively, the external keyboard may be in communication with the electronic device 2 through a wireless transmission module in a wireless transmission manner.

However, the above supporting device 1 still has some drawbacks. For example, when the supporting device 1 is used in the second approach, the electronic device 2 is supported by the supporting device 1 through the covering plate 115 and the stopping plates 111 only. Due to the weight of the electronic device 2, the electronic device 2 is readily slid. Under this circumstance, the electronic device 2 is not supported by the supporting device 1, and thus the electronic device 2 collides with a working surface (e.g., a desk surface). In other words, the supporting force provided by the supporting device 1 is usually insufficient. Therefore, there is a need of providing a supporting device for securely fixing an electronic device.

### SUMMARY OF THE INVENTION

An object of the present invention provides a supporting device for securely fixing an electronic device.

In accordance with an aspect of the present invention, there is provided a supporting device for fixing and supporting an electronic device. The supporting device includes a base, a fixing plate, a supporting frame and a rotating module. The base is placed on a working surface. The fixing plate is selectively closed or opened. When the fixing plate is closed, the base is covered by the fixing plate. When the fixing plate is rotated relative to the base and opened, the electronic device is fixed on the fixing plate. The supporting frame is selectively closed or opened. When the supporting frame is closed, the fixing plate is covered by the supporting frame. When the supporting frame is rotated relative to the fixing plate and opened, the supporting frame is contacted with the working surface. The rotating module is connected with the base, the fixing plate and the supporting frame. The fixing plate is rotatable relative to the base through the rotating module, and the supporting frame is rotatable relative to the fixing plate through the rotating module. After the fixing plate is rotated relative to the base and the supporting frame is correspondingly rotated with fixing plate by a predetermined angle, the supporting frame is rotated relative to the fixing plate in a first direction until the supporting frame is contacted with the working surface, or the supporting frame is rotated relative to the fixing plate in a second direction to push the fixing plate until the base is covered by the supporting frame.

From the above descriptions, the present invention provides the supporting device for the electronic device. The rotating module is configured to control the opened states and the closed states of the fixing plate and the supporting frame. By simply uplifting or covering the fixing plate, the operations of the fixing plate and the supporting frame can be controlled as required. That is, it is not necessary to individually operate the fixing plate and the supporting frame. If the included angle between the fixing plate and the base is not in the free angle range before the fixing plate is rotated by the predetermined angle, the fixing plate and the supporting frame are synchronously rotated. After the fixing plate is rotated by the predetermined angle, the supporting frame is rotatable relative to the fixing plate without being additionally uplifted or covered. Consequently, the procedure of operating the supporting device is simplified. Moreover, the arrangement of the supporting frame can increase the supporting force through the contact between the supporting frame and the working surface. Moreover, since the operation of the second rotating mechanism allows the fixing plate to resist the rotation, the problem of causing collision between the electronic device and the base is avoided.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic exploded view illustrating a conventional supporting device for an electronic device;

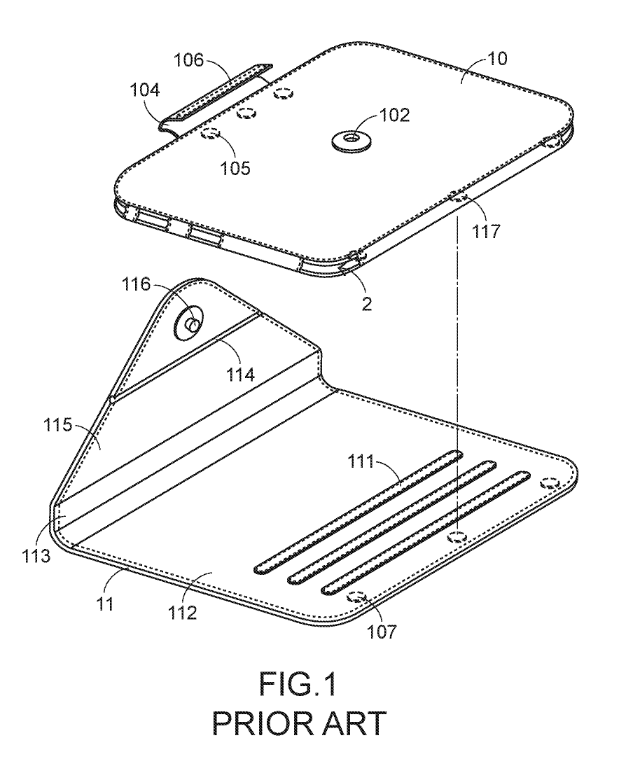

FIG. 2 is a schematic perspective view illustrating the conventional supporting device in a storing mode;

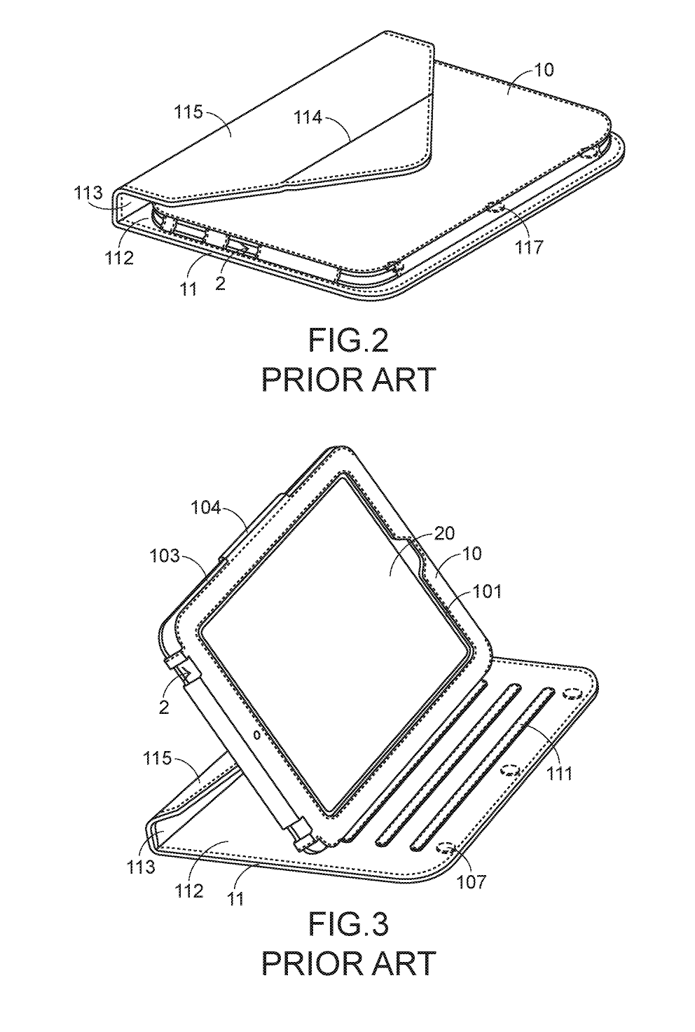

FIG. 3 is a schematic perspective view illustrating the conventional supporting device in an operating mode;

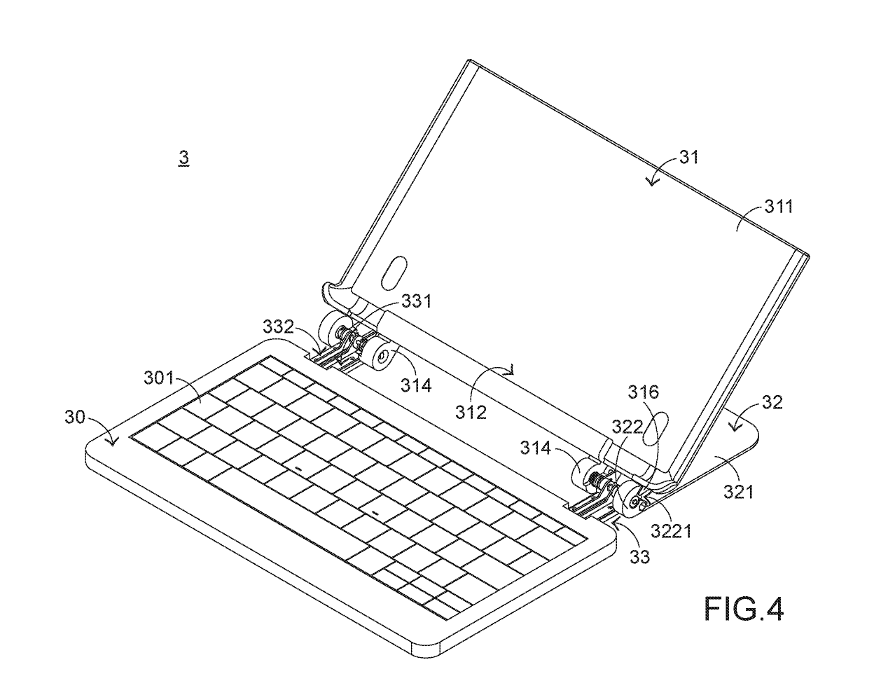

FIG. 4 is a schematic perspective view illustrating the outer appearance of a supporting device according to an embodiment of the present invention;

FIG. 5 is a schematic perspective view illustrating the supporting device according to the embodiment of the present invention and in an operating mode;

FIG. 6 is a schematic side view illustrating the supporting device of FIG. 5;

FIG. 7 is a schematic perspective view illustrating the supporting device according to the embodiment of the present invention and in a storing mode;

FIG. 8 is a schematic perspective view illustrating the structure of the rotating module of the supporting device according to the embodiment of the present invention; and

FIGS. 9A and 9B are schematic exploded view illustrating the structure of the rotating module of the supporting device according to the embodiment of the present invention and taken along different viewpoints.

### DETAILED DESCRIPTION OF THE PREFERRED EMBODIMENT

For overcoming the drawbacks of the conventional technologies, the present invention provides a supporting device for an electronic device.

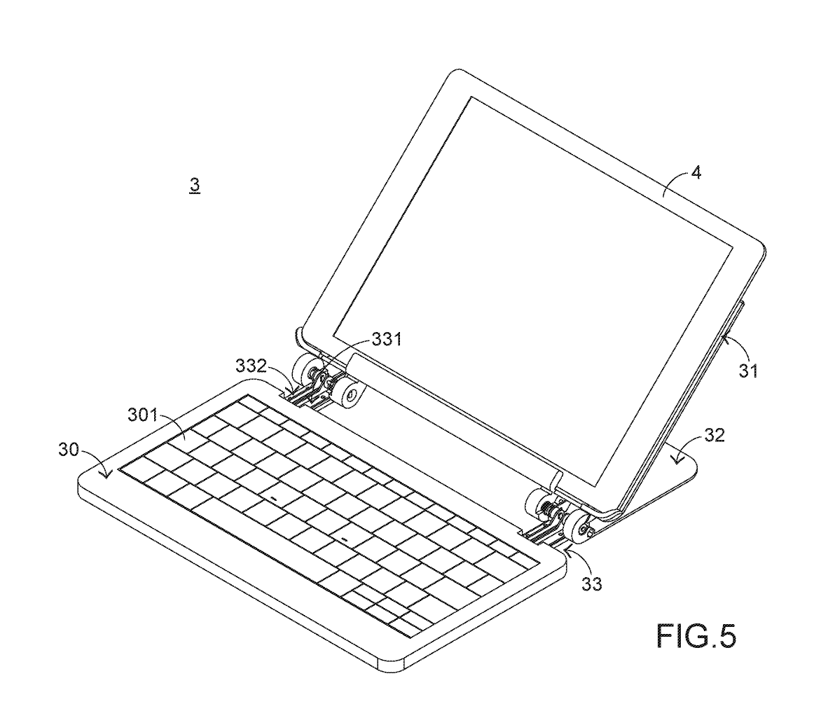

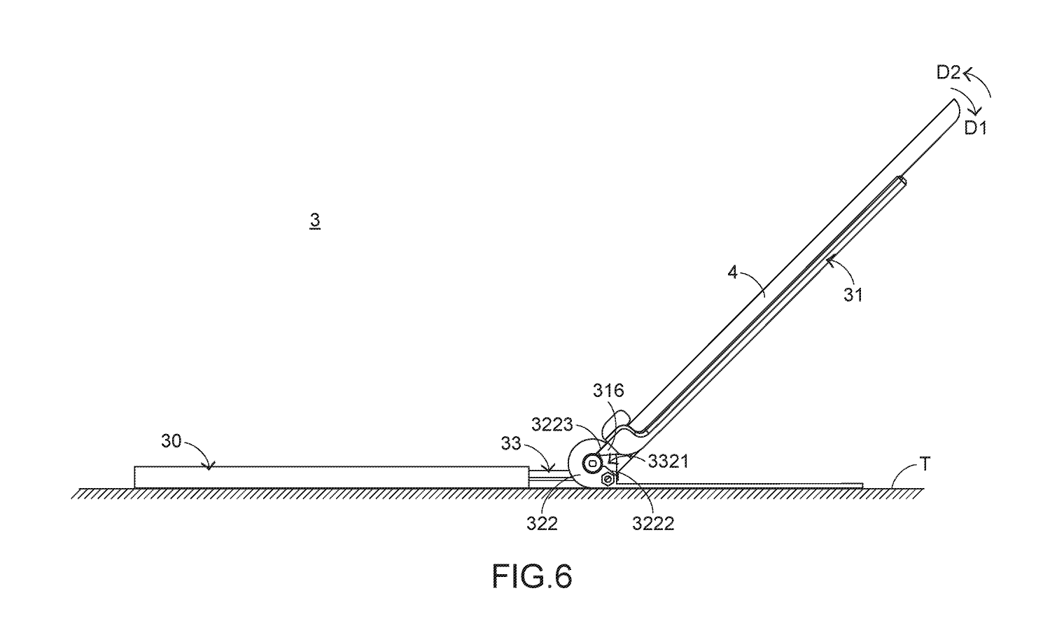

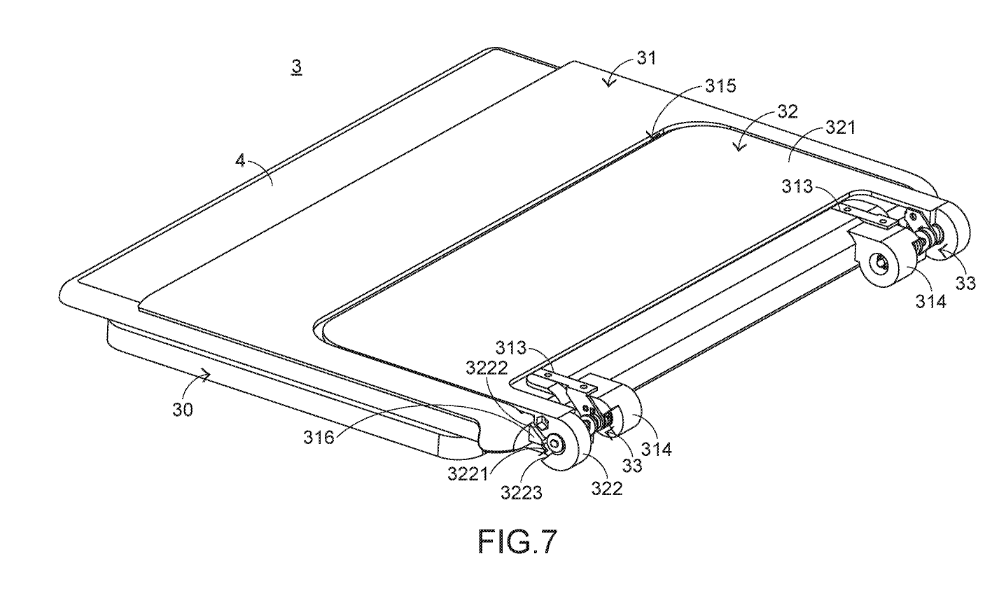

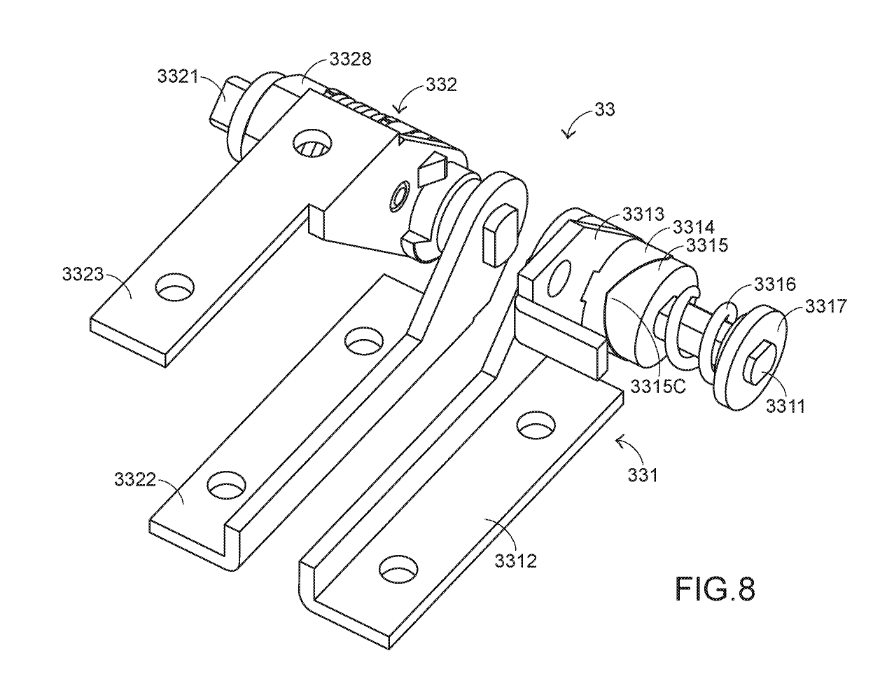

Please refer to FIGS. 4, 5, 6 and 7. FIG. 4 is a schematic perspective view illustrating the outer appearance of a supporting device according to an embodiment of the present invention. FIG. 5 is a schematic perspective view illustrating the supporting device according to the embodiment of the present invention and in an operating mode. FIG. 6 is a schematic side view illustrating the supporting device of FIG. 5. FIG. 7 is a schematic perspective view illustrating the supporting device according to the embodiment of the present invention and in a storing mode. The supporting device 3 comprises a base 30, a fixing plate 31, a supporting frame 32 and plural rotating modules 33. The supporting device 3 is used for fixing an electronic device 4 and supporting the electronic device 4 if required. The base 30 is placed on a working surface T. The base 30 comprises a keyboard 301 with plural keys. The keyboard 301 is exposed to a top surface of the base 30. When one of the plural keys of the keyboard 301 is pressed by the user, a corresponding key signal is generated. When the electronic device 4 is supported on the supporting device 3, the keyboard 301 is in communication with the electronic device 4 in a wireless transmission manner or a wired transmission manner. Consequently, the key signal can be transmitted from the keyboard 301 to the electronic device 4. The fixing plate 31 can be selectively closed or opened. When the fixing plate 31 is closed, the base 30 is covered by the fixing plate 31. When the fixing plate 31 is rotated relative to the base 30 in a direction away from the base 30, the fixing plate 31 is opened from the base 30. Moreover, the electronic device 4 can be fixed on the fixing plate 31. In the situation of FIG. 7, the fixing plate 31 and the supporting frame 32 are in the closed state to cover the base 30. An example of the electronic device 4 is a tablet computer, a smart phone or any other appropriate handheld electronic device.

The supporting frame 32 is selectively closed or opened. When the supporting frame 32 is closed, the fixing plate 31 is covered by the supporting frame 32. When the supporting frame 32 is rotated relative to the fixing plate 31 and contacted with the working surface T, the supporting frame 32 is opened. The supporting frame 32 in the opened state provides a supporting force. In response to the supporting force, the supporting device 3 is not overturned.

Each of the rotating modules 33 is connected with the base 30, the fixing plate 31 and the supporting frame 32. Through the rotating module 33, the fixing plate 31 is rotatable relative to the base 30 and the supporting frame 32 is rotatable relative to the fixing plate 31. The operation of the supporting device 3 in response to the rotation of the rotating module 33 will be described as follows. Firstly, in response to an external force of the user, the fixing plate 31 is rotated relative to the base 30 in a first direction D1. As the fixing plate 31 is rotated, the supporting frame 32 is correspondingly rotated. After the fixing plate 31 is rotated by a predetermined angle A, the supporting frame 32 is rotated relative to the fixing plate 31 in the first direction D1 until the supporting frame 32 is contacted with the working surface T (see FIG. 6). Alternatively, in response to an external force of the user, the fixing plate 31 is rotated relative to the base 30 in a second direction D2. As the fixing plate 31 is rotated, the supporting frame 32 is correspondingly rotated. After the fixing plate 31 is rotated by the predetermined angle A, the supporting frame 32 is rotated relative to the fixing plate 31 to push the fixing plate 31 in the second direction D2 until the base 30 is covered by the supporting frame 32 (see FIG. 7). In an embodiment, the predetermined angle A is in the range between 80 and 100 degrees.

Please refer to FIG. 4 again. Each rotating module 33 comprises a first rotating mechanism 331 and a second rotating mechanism 332. The first rotating mechanism 331 is connected with the base 30 and the supporting frame 32. Moreover, the supporting frame 32 is rotatable relative to the base 30 through the first rotating mechanism 331. The second rotating mechanism 322 is connected with the base 30 and the fixing plate 31. The fixing plate 31 is rotatable relative to the base 30 through the second rotating mechanism 332. Moreover, the second rotating mechanism 332 provides an elastic force to the fixing plate 31. For covering the fixing plate 31 on the base 30, the external force is applied to the fixing plate 31 by the user. In response to the external force, the fixing plate 31 is rotated relative to the base 30 in the second direction D2. Since the elastic force provided by the second rotating mechanism 332 can resist a portion of the applied external force. Consequently, the fixing plate 31 is not quickly moved toward the base 30 in response to the weight of the electronic device 4. In other words, the problem of causing collision between the electronic device 4 and the base 30 is avoided.

After the fixing plate 31 is rotated relative to the base 30 in the first direction D1 in response to the external force of the user and the supporting frame 32 is correspondingly rotated with the fixing plate 31 by the predetermined angle A, the supporting frame 32 is rotated relative to the fixing plate 31 through the first rotating mechanism 331 until the supporting frame 32 is contacted with the working surface T. After the fixing plate 31 is rotated relative to the base 30 in the second direction D2 in response to the external force of the user and the supporting frame 32 is correspondingly rotated with the fixing plate 31 by the predetermined angle A, the supporting frame 32 is rotated relative to the fixing plate 31 through the first rotating mechanism 331 in order to push rotation of the fixing plate 31 toward the base 30 (i.e., in the second direction D2).

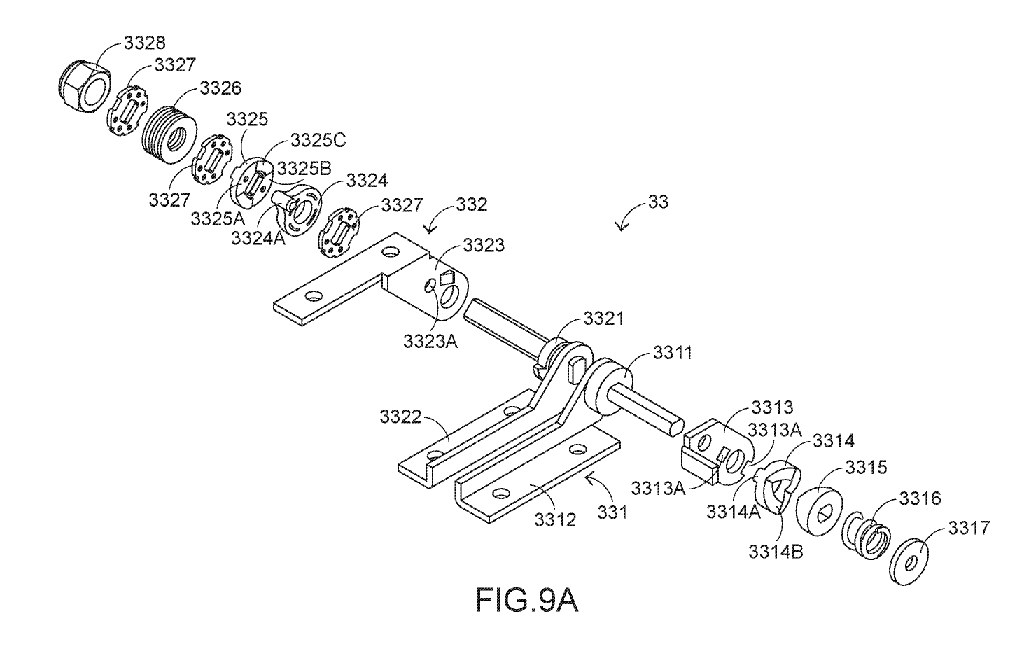

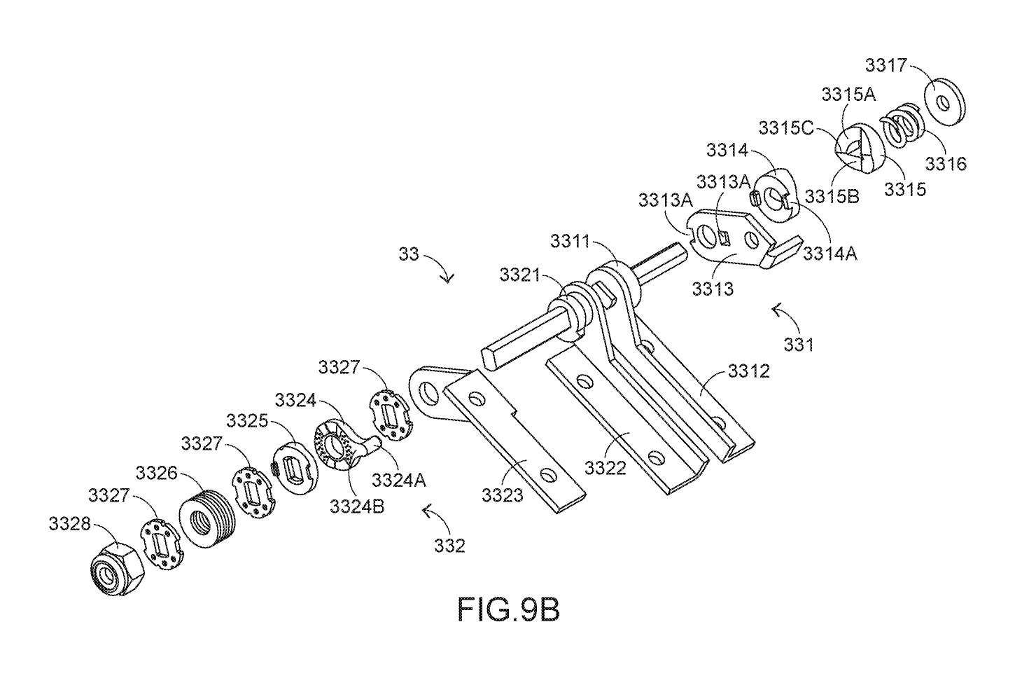

Hereinafter, the structure of the rotating module 33 will be described in more detail with reference to FIGS. 8, 9A and 9B. FIG. 8 is a schematic perspective view illustrating the structure of the rotating module of the supporting device according to the embodiment of the present invention. FIGS. 9A and 9B are schematic exploded view illustrating the structure of the rotating module of the supporting device according to the embodiment of the present invention and taken along different viewpoints.

The first rotating mechanism 331 of the rotating module 33 comprises a first shaft 3311, a first connecting part 3312, a second connecting part 3313, a first cam 3314, a second cam 3315, a first elastic element 3316 and a stopper 3317. The first connecting part 3312 is installed on the first shaft 3311 and connected with the base 30. The first shaft 3311 is fixed on the base 30 through the first connecting part 3312. The second connecting part 3313 is installed on the first shaft 3311 and rotatable relative to the first shaft 3311. The first rotating mechanism 3311 is connected with the supporting frame 32 through the second connecting part 3313. Moreover, the second connecting part 3313 comprises plural first coupling structures 3313A. The first cam 3314 is installed on the first shaft 3311 and fixed on the second connecting part 3313. Consequently, the first cam 3314 is rotated with the second connecting part 3313. The first cam 3314 comprises plural first complementary coupling structures 3314A corresponding to the plural first coupling structures 3313A. The plural first complementary coupling structures 3314A are coupled with the corresponding first coupling structures 3313A, and thus the first cam 3314 is rotated with the second connecting part 3313. In an embodiment, the first coupling structures 3313A are openings, and the first complementary coupling structures 3314A are bulges.

The second cam 3315 is installed on the first shaft 3311. The second cam 3315 is not rotated relative to the first shaft 3311, but the second cam 3315 is movable relative to the first cam 3314. The second cam 3315 is located beside the first cam 3314. While the first cam 3314 is rotated with the second connecting part 3313, the second cam 3315 is pushed by the rotating first cam 3314. Consequently, the second cam 3315 is moved on the first shaft 3311. The first elastic element 3316 is installed on the first shaft 3311 and located beside the second cam 3315. As the second cam 3315 is moved, the first elastic element 3316 is pushed by the second cam 3315. Consequently, the first elastic element 3316 is compressed to store a first elastic force. The stopper 3317 is installed on the first shaft 3311 and contacted with the first elastic element 3316. By the stopper 3317, the first elastic element 3316 is not detached from the first shaft 3311. Moreover, the stopper 3317 can support the first elastic element 3316. Consequently, the first elastic element 3316 can be switched between the compressed state and a released state. In this embodiment, the first elastic element 3316 is a spring.

The first cam 3314 further comprises a first convex structure 3314B. The second cam 3315 further comprises a first concave structure 3315A, a second concave structure 3315B and a second convex structure 3315C. The second convex structure 3315C is arranged between the first concave structure 3315A and the second concave structure 3315B. When the second cam 3315 is not pushed by the first cam 3314, the first convex structure 3314B is inserted in the first concave structure 3315A. Consequently, the first cam 3314 is engaged with the second cam 3315.

The second rotating mechanism 332 of the rotating module 33 comprises a second shaft 3321, a third connecting part 3322, a fourth connecting part 3323, a third cam 3324, a fourth cam 3325, a second elastic element 3326, plural gaskets 3327 and a fastening element 3328. The third connecting part 3322 is installed on the second shaft 3321 and connected with the base 30. The second shaft 3321 is fixed on the base 30 through the third connecting part 3322. The fourth connecting part 3323 is installed on the second shaft 3321 and rotatable relative to the second shaft 3321. The second rotating mechanism 332 is connected with the fixing plate 31 through the fourth connecting part 3323. Moreover, the fourth connecting part 3323 comprises plural second coupling structures 3323A. The third cam 3324 is installed on the second shaft 3321 and fixed on the fourth connecting part 3323. Consequently, the third cam 3324 is rotated with the fourth connecting part 3323. The third cam 3324 comprises plural second complementary coupling structures 3324A corresponding to the plural second coupling structures 3323A. The plural second complementary coupling structures 3324A are coupled with the corresponding second coupling structures 3323A, and thus the third cam 3324 is rotated with the fourth connecting part 3323. In an embodiment, the second coupling structures 3323A are openings, and the second complementary coupling structures 3324A are bulges.

The fourth cam 3325 is installed on the second shaft 3321. The fourth cam 3325 is not rotated relative to the second shaft 3321, but the fourth cam 3325 is movable relative to the third cam 3324. The fourth cam 3325 is located beside the third cam 3324. While the third cam 3324 is rotated with the fourth connecting part 3323, the fourth cam 3325 is pushed by the rotating third cam 3324. Consequently, the fourth cam 3325 is moved on the second shaft 3321. The second elastic element 3326 is installed on the second shaft 3321 and located beside the fourth cam 3325. As the fourth cam 3325 is moved, the second elastic element 3326 is pushed by the fourth cam 3325. Consequently, the second elastic element 3326 is compressed to store a second elastic force. The plural gaskets 3327 are installed on the second shaft 3321. The plural gaskets 3327 are used for adjusting the position of at least one of the third cam 3324, the fourth cam 3325 and the second elastic element 3326. The fastening element 3328 is located at an end of the second shaft 3321. The fastening element 3328 is used for fixing the third cam 3324, the fourth cam 3325 and the second elastic element 3326 on the second shaft 3321. In an embodiment, the second elastic element 3326 comprises plural elastic sheets.

The third cam 3324 further comprises a third convex structure 3324B. The fourth cam 3325 further comprises a third concave structure 3325A, a fourth concave structure 3325B and a fourth convex structure 3325C. The fourth convex structure 3325C is arranged between the third concave structure 3325A and the fourth concave structure 3325B. When the fourth cam 3325 is not pushed by the third cam 3324, the third convex structure 3324B is inserted in the third concave structure 3325A. Consequently, the third cam 3324 is engaged with the fourth cam 3325.

Preferably, the elasticity coefficient of the second elastic element 3326 is larger than the elasticity coefficient of the first elastic element 3316. Consequently, the compressing extent of the second elastic element 3326 is smaller when the second elastic element 3326 is pushed, and the compressing extent of the first elastic element 3316 is larger when the first elastic element 3316 is pushed. According to this design, the supporting frame 32 connected with the first rotating mechanism 331 has a jumping action, and the fixing plate 31 connected with the second rotating mechanism 332 provides the second elastic force continuously. Consequently, the problem of causing collision between the electronic device 4 and the base 30 is avoided. Because of the above reasons, the slope and the thickness of the first convex structure 3314B of the first cam 3314 are larger than the slope and the thickness of the third convex structure 3324B of the third cam 3324. The relationship between the second cam 3315 and the fourth cam 3325 are similar to the relationship between the first cam 3314 and the third cam 3324. In other words, the required elastic force is determined according to the shapes of the first cam 3314, the second cam 3315, the third cam 3324 and the fourth cam 3325 and the slopes and thicknesses of the concave structures of these cams.

The structures of the fixing plate 31 and the supporting frame 32 will be described in more detail as follows. Please refer to FIGS. 4, 6 and 7. The fixing plate 31 comprises a main body 311, a stopping slice 312, a connecting structure 313, plural protective sheaths 314, a receiving recess 315 and plural protrusions 316. The stopping slice 312 is protruded externally from the main body 311. The electronic device 4 can be accommodated within the space between the stopping slice 312 and the main body 311. The connecting structure 313 is disposed on the main body 311. The connecting structure 313 is connected with the fourth connecting part 3323. The protective sheaths 314 are protruded externally from the main body 311. The protective sheaths 314 can shelter a portion of the second rotating mechanism 322. Consequently, the third cam 3324, the fourth cam 3325 and the second elastic element 3326 are not exposed to the outside. The receiving recess 315 corresponds to the supporting frame 32. The supporting frame 32 can be accommodated within the receiving recess 315. The plural protrusions 316 are protruded downwardly from a bottom edge of the fixing plate 31. In an embodiment, the connecting structure 313, the plural protective sheaths 314 and the plural protrusions 316 are integrally formed with the main body 311.

The supporting frame 32 comprises a frame body 321 and plural second protective sheaths 322. The frame body 321 can be contacted with the working surface T. Each protective sheath 322 is connected with the frame body 321. The protective sheath 322 is contacted with the second connecting part 3313, and thus the protective sheath 322 is connected with the first rotating mechanism 331. In an embodiment, the protective sheath 322 comprises an indentation 3221, a first position-limiting wall 3222 and a second position-limiting wall 3223. The indentation 3221 is formed in a sidewall of the protective sheath 322. A portion of the fixing plate 31 is inserted into the indentation 3221. The first position-limiting wall 3222 is located at a first side of the indentation 3221 and contactable with the fixing plate 31. The second position-limiting wall 3223 is located at a second side of the indentation 3221 and contactable with the fixing plate 31. Moreover, each indentation 3221 is aligned with the corresponding protrusion 316.

The operations of the supporting device 3 will be described as follows. Please refer to FIGS. 4-9B. When the supporting device 3 is in the storing state as shown in FIG. 7, the supporting frame 32 is accommodated within a receiving recess 315. Meanwhile, the first convex structure 3314B of the first cam 3314 is inserted in the first concave structure 3315A of the second cam 3315. When the user wants to operate the electronic device 4, the user applies an external force to the fixing plate 31 (or the electronic device 4 on the fixing plate 31). Consequently, the fixing plate 31 is rotated relative to the base 30 in the first direction D1. While the fixing plate 31 is rotated in the first direction D1, the plural protrusions 316 of the fixing plate 31 are contacted with the first position-limiting walls 3222 of the corresponding indentations 3221. Consequently, the supporting frame 32 is correspondingly rotated in the first direction D1. While the supporting frame 32 is rotated in the first direction D1, the second connecting part 3313 is correspondingly rotated relative to the first shaft 3311 and the first cam 3314 is rotated with the second connecting part 3313 in the first direction D1. Consequently, the first convex structure 3314B of the first cam 3314 is rotated along the edge of the first concave structure 3315A of the second cam 3315. Under this circumstance, the second cam 3315 is pushed by the first cam 3314.

The supporting frame 32 is continuously rotated with the fixing plate 31 in the first direction D1. When the supporting frame 32 is rotated with the fixing plate 31 by the predetermined angle A, the first convex structure 3314B is separated from the first concave structure 3315A but contacted with the second convex structure 3315C. Meanwhile, the pushing force of the first cam 3314 on the second cam 3315 is the largest. Consequently, the supporting frame 32 that is connected with the second connecting part 3313 is separated from the fixing plate 31, and the supporting frame 32 is rotatable relative to the fixing plate 31. After the supporting frame 32 is rotated with the fixing plate 31 by the predetermined angle A, the included angle between the fixing plate 31 and the base 30 is in a free angle range. Since the second cam 3315 is pushed by the first cam 3314, the first convex structure 3314B is moved across the second convex structure 3315C and moved to the second concave structure 3315B. In response to the movement of the second cam 3315, the supporting frame 32 is rotated relative to the fixing plate 31 until the supporting frame 32 is contacted with the working surface T. Preferably, the free angle range is between 120 and 160 degrees.

While the fixing plate 31 and the supporting frame 32 are rotated relative to the base 30 in the first direction D1, the fourth connecting part 3323 is rotated with the fixing plate 31 and the third cam 3324 is rotated with the fourth connecting part 3323. Since the fourth cam 3325 is pushed by the rotating third cam 3324, the fourth cam 3325 is movable on the second shaft 3321. As the fourth cam 3325 is moved to push the second elastic element 3326, the second elastic element 3326 generates the second elastic force. As the fixing plate 31 is rotated, the third convex structure 3324B of the third cam 3324 is rotated to push the third concave structure 3325A, the fourth convex structure 3325C and the fourth concave structure 3325B of the fourth cam 3325 sequentially. Since the fourth cam 3325 is pushed by the third cam 3324, the fourth cam 3325 is moved on the second shaft 3321. Moreover, in response to the movement of the fourth cam 3325, the second elastic element 3326 provides different strength of the second elastic force. The second elastic force provides a supporting force to the supporting device 3. In response to the supporting force, the supporting device 3 is not overturned by the weight of the electronic device 4.

When the included angle between the fixing plate 31 and the base 30 is in the free angle range, the fixing plate 31 and the supporting frame 32 can be rotated independently and not interfered with each other. The free angle range is determined according to the design of the indentation 3221 of the supporting frame 32. In case that the distance between the first position-limiting wall 3222 and the second position-limiting wall 3223 is increased, the free angle range is increased. In case that the distance between the first position-limiting wall 3222 and the second position-limiting wall 3223 is decreased, the free angle range is decreased. That is, the required free angle range is obtained according to the design of the indentation 3221 of the supporting frame 32.

After the electronic device 4 is used, the supporting device 3 can be restored from the operating mode of FIG. 6 to the storing mode of FIG. 7. By applying an external force to the fixing plate 31 (or the electronic device 4 on the fixing plate 31), the fixing plate 31 is rotated relative to the base 30 in the second direction D2. Since the included angle between the fixing plate 31 and the base 30 is in the free angle range, the supporting frame 32 is not rotated with the fixing plate 31. As the fixing plate 31 is continuously rotated in the second direction D2, the included angle between the fixing plate 31 and the base 30 is not in the free angle range. Meanwhile, the second position-limiting wall 3223 is pushed by the protrusion 316, and thus the supporting frame 32 is rotated with the fixing plate 31 in the second direction D2.

As the fixing plate 31 is continuously rotated relative to the base 30 in the second direction D2, the supporting frame 32 is rotated with the fixing plate 31 by the predetermined angle A. Meanwhile, the second cam 3315 is pushed by the first cam 3314. Consequently, the first cam 3314 that is originally received in the second concave structure 3315B is moved toward the first concave structure 3315A, the second cam 3315 is moved on the first shaft 3311, and the supporting frame 32 is rotated relative to the fixing plate 31 in response to the movement of the second cam 3315. As the supporting plate 32 is gradually rotated toward the fixing plate 31, the supporting plate 32 is contacted with the fixing plate 31. Moreover, in response to the force of moving the second cam 3315, the fixing plate 31 is rotated in the second direction D2. Consequently, the supporting device 3 is restored to the storing mode.

From the above descriptions, the present invention provides the supporting device for the electronic device. The rotating module is configured to control the opened states and the closed states of the fixing plate and the supporting frame. By simply uplifting or covering the fixing plate, the operations of the fixing plate and the supporting frame can be controlled as required. That is, it is not necessary to individually operate the fixing plate and the supporting frame. If the included angle between the fixing plate and the base is not in the free angle range before the fixing plate is rotated by the predetermined angle, the fixing plate and the supporting frame are synchronously rotated. After the fixing plate is rotated by the predetermined angle, the supporting frame is rotatable relative to the fixing plate without being additionally uplifted or covered. Consequently, the procedure of operating the supporting device is simplified. Moreover, the arrangement of the supporting frame can increase the supporting force through the contact between the supporting frame and the working surface. Moreover, since the operation of the second rotating mechanism allows the fixing plate to resist the rotation, the problem of causing collision between the electronic device and the base is avoided.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all modifications and similar structures.

What is claimed is:

1. A supporting device for fixing and supporting an electronic device, the supporting device comprising:
a base placed on a working surface;
a fixing plate selectively closed or opened, wherein when the fixing plate is closed, the base is covered by the fixing plate, wherein when the fixing plate is rotated relative to the base and opened, the electronic device is fixed on the fixing plate;
a supporting frame selectively closed or opened, wherein when the supporting frame is closed, the fixing plate is covered by the supporting frame, wherein when the supporting frame is rotated relative to the fixing plate and opened, the supporting frame is contacted with the working surface; and
a rotating module connected with the base, the fixing plate and the supporting frame, wherein the fixing plate is rotatable relative to the base through the rotating module, and the supporting frame is rotatable relative to the fixing plate through the rotating module, wherein after the fixing plate is rotated relative to the base and the supporting frame is correspondingly rotated with fixing plate by a predetermined angle, the supporting frame is rotated relative to the fixing plate in a first direction until the supporting frame is contacted with the working surface, or the supporting frame is rotated relative to the fixing plate in a second direction to push the fixing plate until the base is covered by the supporting frame.

2. The supporting device according to claim 1, wherein the rotating module comprises:
a first rotating mechanism connected with the base and the supporting frame, wherein the supporting frame is rotatable relative to the base through the first rotating mechanism; and
a second rotating mechanism connected with the base and the fixing plate, wherein the fixing plate is rotatable relative to the base through the second rotating mechanism, and an elastic force is provided by the second rotating mechanism,
wherein after the fixing plate is rotated relative to the base in the first direction and the supporting frame is correspondingly rotated with the fixing plate by the predetermined angle, the supporting frame is rotated relative to the fixing plate through the first rotating mechanism until the supporting frame is contacted with the working surface, wherein after the fixing plate is rotated relative to the base in the second direction and the supporting frame is correspondingly rotated with the fixing plate by the predetermined angle, the supporting frame is rotated relative to the fixing plate through the first rotating mechanism so as to push rotation of the fixing plate toward the base.

3. The supporting device according to claim 2, wherein the first rotating mechanism comprises:
a first shaft;
a first connecting part installed on the first shaft and connected with the base, wherein the first shaft is fixed on the base through the first connecting part;
a second connecting part installed on the first shaft and rotatable relative to the first shaft, wherein the second connecting part is connected with the supporting frame;
a first cam installed on the first shaft and fixed on the second connecting part, wherein the first cam is rotated with the second connecting part;
a second cam installed on the first shaft and located beside the first cam, wherein the second cam is not rotated relative to the first shaft, wherein while the first cam is rotated with the second connecting part, the second cam is pushed by the first cam, so that the second cam is moved on the first shaft; and
a first elastic element installed on the first shaft and located beside the second cam, wherein as the second cam is moved, the first elastic element is pushed by the second cam.

4. The supporting device according to claim 3, wherein after the fixing plate is rotated relative to the base in the first direction and the supporting frame is rotated with the fixing plate by the predetermined angle, the second cam is pushed by the first cam, a position of the first cam is changed from a first concave structure of the second cam to a second concave structure of the second cam to result in a movement of the second cam on the first shaft, and the supporting frame is rotated relative to the fixing plate in response to the movement of the second cam until the supporting frame is contacted with the working surface, wherein after the fixing plate is rotated relative to the base in the second direction and the supporting frame is rotated with the fixing plate by the predetermined angle, the second cam is pushed by the first cam, the position of the first cam is changed from the second concave structure to the first concave structure to result in the movement of the second cam on the first shaft, and the supporting frame is rotated relative to the fixing plate in response to the movement of the second cam so as to push rotation of the fixing plate in the second direction.

5. The supporting device according to claim 3, wherein the supporting frame comprises:
a frame body; and
a protective sheath connected with the frame body, wherein the protective sheath is contacted with the second connecting part, so that the protective sheath is connected with the first rotating mechanism, wherein the protective sheath comprises:
an indentation formed in a sidewall of the protective sheath, wherein the fixing plate is partially inserted into the indentation;
a first position-limiting wall located at a first side of the indentation and contactable with the fixing plate; and
a second position-limiting wall located at a second side of the indentation and contactable with the fixing plate.

6. The supporting device according to claim 5, wherein while the fixing plate is rotated relative to the base in the first direction, a protrusion of the fixing plate is contacted with the first position-limiting wall of the supporting frame to drive rotation of the supporting frame in the first direction, wherein while the fixing plate is rotated relative to the base in the second direction and an included angle between the fixing plate and the base is not in a free angle range, the protrusion is contacted with the second position-limiting wall to drive rotation of the supporting frame in the second direction, wherein when the included angle between the fixing plate and the base is in the free angle range, the rotation of the supporting frame is not interfered by the fixing plate.

7. The supporting device according to claim 3, wherein the second connecting part comprises a first coupling structure, and the first cam comprises a first complementary coupling structure corresponding to the first coupling structure, wherein the first complementary coupling structure is coupled with the first coupling structure, so that the first cam is rotated with the second connecting part.

8. The supporting device according to claim 2, wherein the second rotating mechanism comprises:
a second shaft;
a third connecting part installed on the second shaft and connected with the base, wherein the second shaft is fixed on the base through the third connecting part;
a fourth connecting part installed on the second shaft and rotatable relative to the second shaft, wherein the fourth connecting part is connected with the fixing plate;
a third cam installed on the second shaft and fixed on the fourth connecting part, wherein the third cam is rotated with the fourth connecting part;
a fourth cam installed on the second shaft and located beside the third cam, wherein the fourth cam is not rotated relative to the second shaft, wherein while the third cam is rotated with the fourth connecting part, the fourth cam is pushed by the third cam, so that the fourth cam is moved on the second shaft; and
a second elastic element installed on the second shaft and located beside the fourth cam, wherein as the fourth cam is moved, the second elastic element is pushed by the fourth cam so as to provide the elastic force.

9. The supporting device according to claim 8, wherein the second rotating mechanism further comprises:
plural gaskets installed on the second shaft, wherein the plural gaskets adjust a position of at least one of the third cam, the fourth cam and the second elastic element; and
a fastening element located at an end of the second shaft, wherein the third cam, the fourth cam and the second elastic element are fixed on the second shaft through the fastening element.

10. The supporting device according to claim 8, wherein the fixing plate comprises:
a main body;
a stopping slice protruded externally from the main body, wherein the electronic device is accommodated within a space between the stopping slice and the main body;
a connecting structure disposed on the main body and connected with the fourth connecting part; and
an additional protective sheath protruded externally from the main body to shelter a portion of the second rotating mechanism.

11. The supporting device according to claim 8, wherein while the fixing plate is rotated relative to the base and an included angle between the fixing plate and the base is in a free angle range, the third cam is rotated with the fourth connecting part, a first convex structure of the third cam pushes a second convex structure of the fourth cam to result in a movement of the fourth cam on the second shaft, and the second elastic element provides the elastic force in response to the movement of the fourth cam.

12. The supporting device according to claim 8, wherein the fourth connecting part comprises a second coupling structure, and the third cam comprises a second complementary coupling structure corresponding to the second coupling structure, wherein the second complementary coupling structure is coupled with the second coupling structure, so that the third cam is rotated with the fourth connecting part.
